(19) United States
(12) Patent Application Publication
(10) Pub. No.: US 2025/0266181 A1
(43) Pub. Date: Aug. 21, 2025

(54) APPARATUS AND METHOD TO REMOVE TRITIUM FROM HIGH VOLUMETRIC WASTEWATERS

(71) Applicant: KOREA ATOMIC ENERGY RESEARCH INSTITUTE, Daejeon (KR)

(72) Inventors: Seung-Yeop LEE, Daejeon (KR); Jang-Soon KWON, Goyang-si (KR)

(21) Appl. No.: 18/857,233

(22) PCT Filed: Nov. 8, 2022
(86) PCT No.: PCT/KR2022/017396

§ 371 Date: Oct. 16, 2024

(30) Foreign Application Priority Data
Apr. 18, 2022 (KR) 10-2022-0047566

(51) Int. Cl. G21F 9/18

(52) U.S. Cl. CPC G21F 9/18

(57) ABSTRACT

The present disclosure relates to an apparatus and method for treating high volumetric wastewater, containing tritium, and more particularly to an apparatus for treating wastewater, containing tritium, includes a container storing wastewater, containing tritium, an LED cable including an LED light source, a gas supply cable, and a transparent cover seating the container, wherein the gas supply cable is provided to supply air and carbon dioxide in a form of fine bubbles, and a method for treating wastewater, containing tritium, includes an operation of pouring wastewater, containing tritium, into a container of the apparatus for treating wastewater, containing tritium; an operation of injecting microalgae into the container; and an operation of inducing photosynthesis by using light of an LED cable under fine bubbles supplied by a gas supply cable.

### TECHNICAL FIELD

The present disclosure relates to a method and apparatus for treating wastewater, containing tritium, and more particularly, to an apparatus capable of purifying tritium in water and high volumetric wastewater containing the same, and a method for treatment thereof using the same.

According to the present disclosure, provided are a biotechnological method and apparatus for removing tritium in water that maximizes removal efficiency of tritium in water by a biotechnological method using photosynthesis of microalgae, particularly a light reaction.

### BACKGROUND ART

In general, heavy water (D20) is used as a coolant and moderator required for an operation of a nuclear reactor in heavy water nuclear power plants. During an output operation of the nuclear reactor, a portion of the heavy water is combined with neutrons to be converted into tritium (³H or T) to generate radiation, and a concentration thereof increases according to operating years of the power plant. Tritium is one of hydrogen isotopes, and is an artificial radioactive element with a mass number of 3 consisting of one proton and two neutrons. Tritium is the heaviest of hydrogen isotopes as well as having beta decay (β-decay), and as a radioactive element with a half-life of 12.3 years, it causes radioactive contamination when used in large quantities.

Tritium emits low-energy beta rays and enters the body through the worker's respiration tract or skin, causing internal exposure. A Tritium Removal Facility (TRF) is commonly operated in heavy water nuclear power plants to reduce the effects of exposure by tritium. However, such a tritium removal facility may not completely remove tritium in the form of water vapor, but may dilute the same with seawater and discharge the same as hot wastewater. Therefore, when using seawater as a drinking water source, tritium (T₂O) in seawater may be a significant issue.

Accordingly, as in the case of the Fukushima nuclear power plant in Japan, wastewater, containing tritium, is often stored in small or large-scale temporary storage tanks. If the situation is unfavorable, there is no proper method to treat wastewater, containing tritium. Meanwhile, Korean Patent No. 2005-0006382 as a technology for a device for removing tritium discloses a system for treating tritium, but the prior art discloses a device for removing tritium from the air, which has a problem in that tritium discharged into the water may not be removed.

That is, there is an increasing need for a technology for effectively treating high volumetric wastewater, containing tritium, present in a liquid phase at home and abroad until now.

### DISCLOSURE OF INVENTION

### Technical Problem

As described above, an aspect of the present disclosure is to provide an apparatus for removing tritium and wastewater, containing tritium, capable of maximizing removal efficiency of tritium in water by a biotechnological method using photosynthesis of microalgae, particularly a light reaction.

Another aspect of the present disclosure is to provide a method that can effectively remove tritium in water and wastewater, containing tritium, by maximizing removal efficiency of tritium in water by a biotechnological method using photosynthesis of microalgae, particularly a light reaction.

### Solution to Problem

According to an aspect of the present disclosure, an apparatus for treating wastewater, containing tritium, is provided, the apparatus for treating wastewater, containing tritium, including: a container for storing wastewater, containing tritium; an LED cable including an LED light source; a gas supply cable; and a transparent cover scaling the container, wherein the gas supply cable is provided to supply air and carbon dioxide in a form of microbubbles.

According to another aspect of the present disclosure, a method for treating wastewater, containing tritium, is provided, the method for treating wastewater, containing tritium, including: an operation of pouring wastewater, containing tritium, into a container of the apparatus for treating wastewater, containing tritium, of the present disclosure; an operation of injecting microalgae into the container; and an operation of inducing photosynthesis by using light of an LED cable under microbubbles supplied by a gas supply cable.

### Advantageous Effects of Invention

According to the present disclosure, a method and apparatus for treating high volumetric tritium-containing wastewater with high efficiency may be provided, and according to the technology of the present disclosure, not only the removal of tritium in water, but also a volume itself of the wastewater, containing tritium, may be significantly reduced, and furthermore, it is possible to prevent emission of tritium in the form of water vapor, thereby solving the problem of contamination of tritium in the air.

### BRIEF DESCRIPTION OF DRAWINGS

FIG. 1 schematically illustrates an apparatus for treating wastewater, containing tritium, of the present disclosure.

FIG. 2(a) schematically illustrates an example of a gas supply cable, and FIG. 2(b) schematically illustrates an example of a nano-porous structure for supplying microbubbles to an end of the cable.

FIG. 3 schematically illustrates a difference in action between nanobubbles (left) and normal bubbles (right), which are microbubbles.

FIGS. 4 (a) to 4 (c) schematically illustrate an example of a shape of an inclined protrusion on a lower surface of a cover, and illustrate the lower surface of the cover in an inverted state.

FIG. 5 schematically illustrates an example of a scaling stopper for air/gas outlet.

FIG. 6 illustrates a removal rate of tritium by various conditions, such as a ratio of LED red light and blue light, microalgae difference, and the like.

### BEST MODE FOR CARRYING OUT THE INVENTION

Hereinafter, preferred embodiments of the present disclosure will be described with reference to the accompanying drawings. However, the embodiments of the present disclosure may be modified in various other forms, and the scope of the present disclosure is not limited to the embodiments described below.

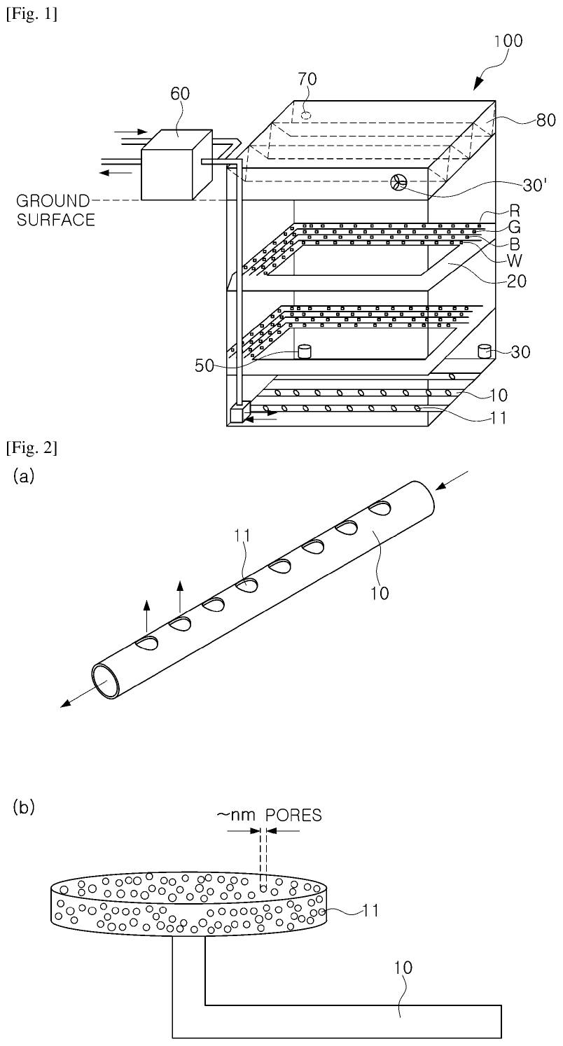

According to the present disclosure, an apparatus and method for treating a high volumetric wastewater, containing tritium, are provided. FIG. 1 schematically illustrates an example of an apparatus for treating wastewater, containing tritium.

In more detail, the apparatus for treating wastewater, containing tritium, of the disclosure includes: a container 100 for storing wastewater, containing tritium; an LED cable 20 including an LED light source; a gas supply cable 10; and a transparent cover 80 for sealing the container, wherein the gas supply cable supplies air and carbon dioxide in a form of microbubbles.

A material of a cable consisting the LED cable and the gas supply cable is not particularly limited as long as it is a waterproof material, and a flexible material is more preferable, and the LED cable is preferably formed of a transparent material through which light can pass. For example, the cable may be a cable manufactured in a form of a tube formed of a flexible polymer resin, for example, polyethylene, polyvinycoverene fluoride (PVPF), or Teflon.

The LED cable preferably includes a combination of a white light source, a red light source, a blue light source, and a green light source for the purpose of providing light of several wavelengths, similar to sunlight, and these light sources may be disposed in one cable in any order, or a combination of these cables may be used by placing each light source on a separate cable.

In the present disclosure, a ratio of a specific wavelength may be increased, among photosynthetic reactions of microalgae, in particular, in order to activate the light reaction. That is, a location in which photosynthesis is performed is a chloroplast, and more specifically, the light reaction is performed in the location known as called chlorophyll on a surface of an inner thylakoid membrane, and mainly absorbs red and blue light in a region of visible light (380˜800 nm). In particular, in the thylakoid membrane, there are two photosystems (photochemical reaction systems) having chlorophyll a and b, which photodecompose water into hydrogen ions (H⁺), electrons (e⁻), and oxygen (O₂), respectively. A Photosystem I absorbs 700 nm of far-red light, and a Photosystem II absorbs 680 nm of red light. Thus, it is necessary to increase a ratio of the red light in order to activate the light reaction among the photosynthetic reactions of microalgae. Therefore, a ratio of the white light source, the red light source, the blue light source, and the green light source is not particularly limited, but for example, the white light source; the red light source; the blue light source; the green light source may be included in a ratio of 10 to 20:50 to 80:20:50:0 to 10. In addition, a general light-dark cycle (ratio) performed in microalgae culture, for example, 12 hours a day: 12 hours a day, is not set separately, but by irradiating LED light continuously for 24 hours a day to further strengthen the light response, so that an effect of tritium decomposition, absorption, and oxygen (O₂) generation by microalgae may be further improved. As described above, by increasing the ratio of the LED red light and irradiating the LED light continuously for 24 hours a day, tritium ions were effectively concentrated in the microalgal cells, specifically in a chloroplast thylakoid membrane.

Luminous intensity of light emitted by the LED cable is preferably 50 to 200 μmol/m²·s, and when the luminous intensity is less than 50 to 200 μmol/m²·s, growth of microalgae may be insufficient, and when the luminous intensity exceeds 50 to 200 μmol/m²·s, there may be a problem such as microalgae necrosis, or the like.

Meanwhile, the gas supply cable is provided to supply a combination of air and/or carbon dioxide in a form of fine bubbles, a ratio of air and carbon dioxide may be adjusted as needed, but for example carbon dioxide may be included in an amount of 0.0 to 0.5 vol % of the total gas. If the amount of carbon dioxide exceeds this amount, pH may drop sharply.

In the present disclosure, the fine bubbles include nano-sized nanobubbles having an average particle diameter of 10 nm to 100 μm, for example, 10 nm to 1,000 nm, and a form of the gas supply cable for supplying gas is not particularly limited as long as it can supply fine bubbles, and for example, a plurality of gas supply units 11, that is, a form of gas supply cable 10 having pores, as illustrated in FIG. 2 (a), may include a nano-porous structure for supplying fine bubbles to an end of the cable, as illustrated in FIG. 2(b). The nano-porous structure may be, for example, a porous structure formed of a material such as artificial stone, a metal material, a high-strength plastic, and the like, and may have pores having a size of several tens of nm or more.

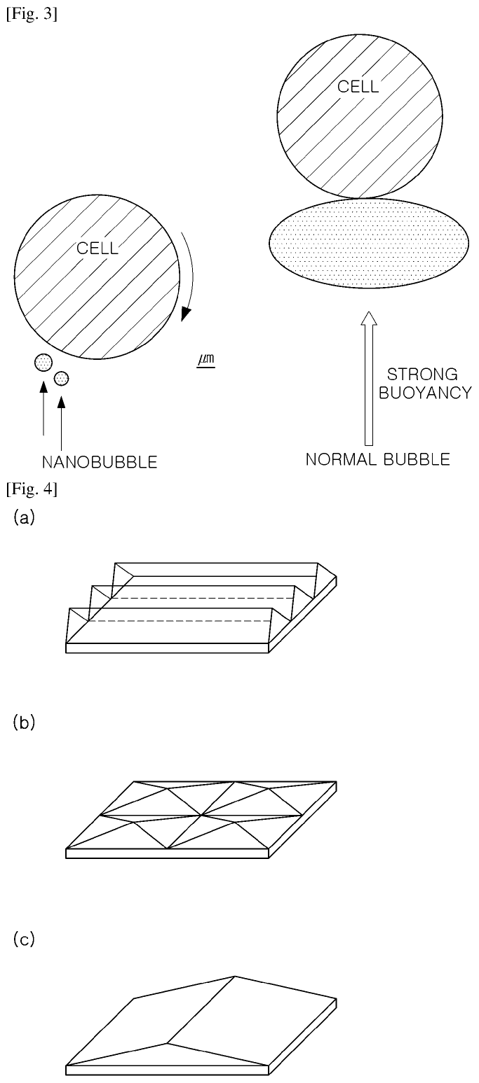

Since the fine bubbles of the present disclosure can give rotation to cells at various angles while covering the same with microalgae as illustrated on a left side of FIG. 3, light energy from the LED light source may be uniformly received from various angles, whereas the normal bubble is difficult to significantly change movement of a cell as illustrated on a right side of FIG. 3. That is, water circulation by strong current makes it difficult to change the movement of each cell, and rather, the strong current may cause strong pressure to impact on an opposite side of the cell, causing the cell to be deformed or stressed. In addition, normal bubbles can strengthen buoyancy of cells, causing cell rise and aggregation of cells on a water surface. Meanwhile, the fine bubbles applied in the present disclosure are not strong in terms of buoyancy and are advantageous in dispersing microalgae, and a surface of the fine bubble has a wide surface area and is negatively charged, so that it is advantageous that tritium ions (³H⁺), which is a cation, are adsorbed onto the bubble and then diffused into cells.

Moreover, since fine bubbles, for example microbubbles or nanobubbles, especially such as nanobubbles are smaller than the size of microalgae, when the nanobubbles collide with a wall of the cell of microalgae, they induce appropriate surface stimulation and activation of cells to help photosynthesis and absorption of tritium water molecules (HTO). In particular, fine bubbles especially such as nanobubbles increase a content of carbon dioxide that can be dissolved in water, which can help cell growth and activation.

As a result, according to the present disclosure, photosynthesis of microalgae according to the following Reaction Formula 1 may be maximized, and tritium in water may be highly concentrated and immobilized as glucose (C₆H₁₂O₆) through a photosynthetic reaction described above.

6CO₂+12H₂O+Light(LED)→C₆H₁₂O₆+6O₂+6H₂O [Reaction formula 1]

As described above, according to the present disclosure, tritium ions (³H⁺ or T⁺) and tritium water molecules (HTO) are smoothly supplied into cells of the microalgae through provision of abundant fine bubbles, thereby helping absorption of tritium into the cells of the microalgae.

In addition, if a ratio and luminosity of red light described above are further increased, and light is continuously irradiated for 24 hours during a wastewater reaction, water decomposition, hydrogen ion concentration and oxygen generation by the light reaction are improved as shown in Reaction formula 2, so that a volume of wastewater is steadily reduced.

12H₂O+12NADP⁺+18ADP+Light(LED)→6O₂+12NADPH+18ATP [Reaction formula 2]

In [Reaction formula 2] related to the light reaction, ATP and NADPH coenzymes are additionally generated. As can be seen from formula described above, in one cycle reaction, 12 molecules of water are decomposed to generate 6 molecules of oxygen, and a volume of water gradually decreases.

According to the present disclosure, since a volume of wastewater containing tritium is reduced by about ⅓ within 10 days, it is easy to reduce the volume of wastewater and facilitate post-management.

Through the generation of fine bubbles and high-ratio red light LED irradiation, tritium absorption and concentration by microalgae is activated and O₂ generation by biophotolysis of water is promoted, so there is an advantage in which tritium absorption and wastewater volume reduction may be performed together. Meanwhile, the gas supply cable is preferably disposed in a lower end portion of the container in which the wastewater is stored, but since the fine bubbles provided by the gas supply cable of the present disclosure do not have a long moving distance, when a depth of the container is deep, the gas supply cable may be disposed for multiple layers in a vertical direction.

In the present disclosure, a feature referred to as a ‘layer’ means, for example, a vertical region or parallel lines in which a gas supply cable exists in the case of a ‘gas supply cable layer.’ For example, the gas supply cable may be formed of a plurality of gas supply cable layers in a vertical direction while being spaced 50 to 100 cm apart from a bottom of the container.

When a depth (height) of the container in which the wastewater is stored is not deep, the gas supply cable may be disposed at a bottom of the container in which the wastewater is stored as illustrated in FIG. 1, and depending on the depth (height) of the container in which the wastewater is stored, the gas supply cable layers may be disposed at regular intervals.

The gas supply cable layer may form a horizontal two-dimensional network, for example, a dispositional form of the gas supply cable such as a plurality of horizontal straight lines as illustrated in FIG. 1, or a continuous S-shaped form connected by a single line, a lattice form, and the like is not particularly limited.

Meanwhile, the LED cable may be disposed in any non-limited form so that light reaches an entire region of the container containing wastewater, for example, the LED cable may be disposed on at least one side surface of the container to form at least one layer, but an embodiment thereof is not limited thereto.

Furthermore, the apparatus for treating wastewater, containing tritium, of the present disclosure may further include a cooler, a heater, or a combination thereof in a container containing wastewater to control a temperature of the container and wastewater, and the cooler is additionally disposed in an upper end portion of the container in which the wastewater is stored, that is, on a side of a device of the region in which gas in an upper portion of the container exists based on a gas-liquid interface between wastewater and air to cool the same, when tritium in a form of water vapor is generated, tritium is cooled and returned into wastewater again, thereby preventing air pollution by tritium escaping through air and/or gas outlet. In this case, the cooler disposed in an upper end portion of the container in which the wastewater is stored may be in a form of a cooling fan. In this case, the cooler disposed in the upper end portion may be operated such that air in the container is cooled to a temperature of 10° C. to 15° C. and moisture is recovered from vapor to wastewater.

Furthermore, the cover of the present disclosure may be formed of, for example, a transparent material, for example, a material such as glass or a transparent polymer resin, and in this case, sufficient sunlight may be supplied from the cover during the day.

Meanwhile, a lower surface of the cover may include one or more inclined protrusions, for example, FIGS. 4(a) to 4(c) illustrate a state in which the lower surface of the cover is inverted. As described above, by forming a structure including a crest and a trough, water vapor, containing tritium, that is evaporated is condensed in an upper portion of the container and may be induced to fall back to the reactor by gravity. However, a form of such an inclined protrusion is not particularly limited, and may be, for example, a structure having an inclination of 10° or more.

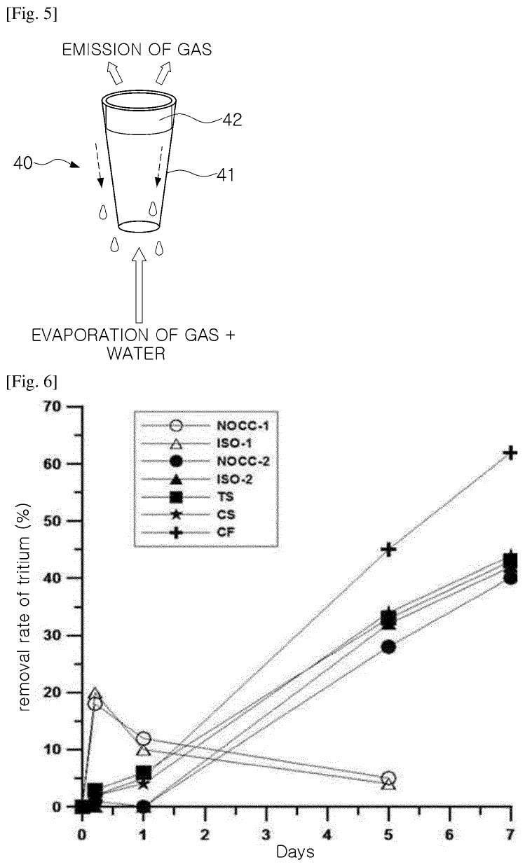

Additionally, if necessary, an air/gas outlet 70 is provided on a side of the cover, and as illustrated in FIG. 5, by installing a sealing stopper 40 including a conical outlet pipe 41 and a moisture condensing filter 42, by inducing trapping of tritium water molecules and returning of trapped condensate into the reactor, only generated gas, for example, oxygen (O₂), air, and the like, may be emitted externally. The material of these structures is not particularly limited, but a material having good thermal conductivity and corrosion resistance is preferable, and for example, a copper material may be used.

In addition, if necessary, a pump and/or a filtering device 60 may be additionally installed.

According to another aspect of the present disclosure, there is provided a method for treating wastewater, containing tritium, using the apparatus for treating wastewater, containing tritium, of the present disclosure.

With respect to the apparatus applied to the method for treating wastewater, containing tritium, of the present disclosure, all of the contents described in relation to the apparatus may be applied.

In more detail, a method for treating wastewater, containing tritium, includes: an operation of pouring wastewater, containing tritium, into a container of the apparatus for treating wastewater, containing tritium, of the present disclosure; an operation of injecting microalgae into the container; and an operation of inducing photosynthesis by using light of an LED cable under fine bubbles supplied by a gas supply cable.

In the present disclosure, the fine bubbles may be supplied in an amount of 1.0 to 20.0 m³/hr, and if the supply of the fine bubbles is less than that, maximization of photosynthesis may not be smoothly performed, and the supply of the fine bubbles may not be smoothly achieved. If the supply of the fine bubbles is excessively performed, bubbles on a water surface will increase, which may block light or increase an amount of evapotranspiration of water.

The microalgae that can be applied to the present disclosure may be at least one selected from Tetraselmis, Dunaliella, Chlorella, Nannochloropsis, Isochrysis, Chlamydomonas, Golenkinia, Hematococcus, Spirulina, Scenedesmus, and Chactoceros. In this case, the microalgae may be added in an amount of 10,000 to 200,000 cells per 1 ml of wastewater, and when the amount thereof is less than this amount, tritium removal efficiency may be reduced, when the amount thereof exceeds this amount, an amount of microalgal sludge and secretions may increase, resulting in decreased cell activity and reduced photosynthetic efficiency.

Meanwhile, the wastewater in the container is preferably maintained at a pH and temperature of pH 6 to 8 and 15 to 25° C., photosynthesis of microalgae can be maximized under these conditions. The pH may be adjusted by adding an acid and/or alkali such as HCl and NaOH to maintain the pH in a range of neutral to slightly alkali.

Hereinafter, the present disclosure will be described in more detail through specific examples. The following examples are only examples to help the understanding of the present disclosure, and the scope of the present disclosure is not limited thereto.

### MODE FOR THE INVENTION

### Example

### 1. Apparatus and Experiment for Removing Tritium and Wastewater, Containing Tritium

A process of the present disclosure for promoting absorption of tritium into microalgae and photolysis of water was applied as follows.

As illustrated in FIG. 1 for wastewater purification, an apparatus including a reactor 100, a pump, and a filter 60 was prepared. Wastewater at room temperature containing tritium was introduced into the reactor, and a temperature of the wastewater was set to 20° C. (±5° C.) through a temperature control device installed in the reactor. In this case, the wastewater was prepared to contain 2,000 Bq/ml of tritium. In addition, an initial pH of wastewater in the reactor was adjusted to 7.0 (±1.0). HCl or NaOH reagent was used to adjust the pH of the wastewater.

Microalgae were injected into the wastewater reactor at a concentration of about 100,000 cell/ml. At first, strong air (containing 0.1% of carbon dioxide) was blown in to prevent microalgae from coagulating with each other (20 m³/hr), and gradually uniform fine bubbles were generated evenly throughout (5-10 m³/hr) so that tritium stimulated the surface of the cell and facilitated internal absorption. In order to prevent the cells from coagulating and precipitating to each other and thus rapidly lowering absorption of tritium, strong normal bubbles (20 m³/hr) were occasionally blown for several minutes.

To compare the activation by light response in photosynthesis of microalgae, an experiment was performed using Nannochloropsis occulata (NOCC), Isochrysis galbana (ISO), Tetraselmis succica (TS), and Chactoceros simplex (CS) as microalgae under the condition that a ratio of blue right (B) is 50% or more in a combination of white light+red green blue light (RGB), and an experiment was performed using Chlorella fusca (CF) as microalgae under the condition that a ratio of red light (R) is 50% or more. LED light was continuously irradiated for 24 hours to facilitate photolysis of water and generation of oxygen (O₂). During the experiment, the number of microalgal cells gradually increased, and a water level of the wastewater was gradually lowered by water decomposition.

In order to prevent a release of tritium to an atmosphere and pollution thereof due to evapotranspiration of wastewater during operation, a cooler 30 upper the reactor was operated to condense water vapor and let it fall downwardly by force of gravity.

When a concentration of tritium was measured in real time and decreased to a target concentration, the reaction was stopped and a pump was operated to discharge purified water and microalgae. In this case, microalgae were separated and filtered through a filtration device, and only purified water was transferred to a storage tank. Wastewater purified below a discharge standard was finally discharged, and the separated and filtered microalgae were finally disposed of.

Meanwhile, an experiment was performed on Nannochloropsis (NOCC) and Isochrysis (ISO) under the same conditions as above, except that a gas supply cable for supplying normal bubbles instead of fine bubbles was applied. Meanwhile, in order to be distinguished from microalgae when fine bubbles are suppled, a case of supplying normal bubbles is indicated by NOCC-1 and ISO-1, and a case in which fine bubbles (nanobubbles) are applied thereto is indicated by NOCC-2 and ISO-2.

2. Results of Removal of Tritium from Wastewater Containing Tritium

### (1) Measurement of Volume Reduction of Wastewater Containing Tritium

A volume reduction amount of wastewater was measured under the experimental conditions performed in 1. As a result of the experiment, overall, a tritium removal rate under the fine bubble condition reached about 40%, and there was a slight difference depending on a ratio of blue light to red light of the LED. In particular, a volume reduction of wastewater by microalgae was different, and about ⅕ or more water was photodecomposed for 8 days and discharged as oxygen gas. In particular, in the case of chlorella (CF), ⅓ or more of the wastewater was photodecomposed, so a volume reduction rate of the wastewater was the highest. This showed that the volume of wastewater is efficiently reduced by the water photodecomposition using microalgae, which is expected to be a great help in reducing the volume of high-concentration tritium wastewater.

TABLE 1

| Experiment | Type of microalgae | | | | | | | |
|---|---|---|---|---|---|---|---|---|
| period | NOCC-1 | ISO-1 | NOCC-2 | ISO-2 | TS | CS | CF | Reference |
| 0 day | 300 | 300 | 300 | 300 | 300 | 300 | 300 | Initial amount of wastewater |
| 4 day | 280 | 282 | 229 | 238 | 245 | 249 | 238 | |
| 8 day | 258 | 270 | 198 | 204 | 228 | 230 | 180 | |
| | 42 | 30 | 102 | 96 | 72 | 70 | 120 | An amount of reduction of |
| | | | | | | | | wastewater in 8 days |
| | | | | | | | | (photosynthetic water |
| | | | | | | | | decomposition) |

*unit: ton

### (2) Measurement of Tritium Removal Rate

Meanwhile, an amount of tritium removed was measured under the experimental conditions performed in 1., and a result thereof is illustrated in a graph in FIG. 6.

After filtering microalgae with a 0.45 μm syringe filter by collecting 4 ml of a solution during the experiment, 4 ml of distilled water and 12 ml of a scintillation solution were mixed to analyze a tritium concentration using a liquid scintillation counter (LSC).

As can be seen in FIG. 6, when fine bubbles were applied, an overall tritiumremoval rate approached about 40%, and showed a slight difference depending on the ratio of the LED blue light and red light. In particular, in the case of chlorella (CF), tritium was removed relatively well, compared to other microalgae, by showing a tritium removal rate of about 60% or more for 7 days, and it can be seen that when a ratio of red light is high, absorption of tritium, cell concentration, and cell removal are further easily performed. On the other hand, it was confirmed that the tritium removal rate was reduced when a normal bubble was used.

### (3) Measurement of Concentration of Tritium in Cells

In order to check whether tritium is diffused and concentrated into microalgal cells in the process of performing the process of 1., microalgae that have reacted for more than about 15 days were isolated and analyzed.

About 20 ml of a solution containing microalgae was collected, centrifuged at 3,000 rpm for 20 minutes, and then a supernatant was discarded and only microalgae were collected. A 5% solution of hydrogen peroxide was mixed with distilled water to make hydrogen peroxide, and the centrifuged microalgae were added and left at room temperature for about 1 day so that CO₂ bubbles were continuously generated. After the reaction was completed, the hydrogen peroxide solution was filtered with a 0.45 μm filter syringe, and the concentration of tritium was analyzed by LSC.

As a result of the analysis, it was confirmed that tritium was captured in most of the microalgal cells, and exhibited a value of about 180 to 380 Bq/ml (based on 15 ml of hydrogen peroxide solution). In particular, in the case of CF microalgae, the concentration of tritium in the cells was about 950 Bq/ml, indicating that tritium absorption and cell concentration among microalgae were performed most excellent.

While example embodiments have been shown and described above, it will be apparent to those skilled in the art that modifications and variations could be made without departing from the scope of the present disclosure as defined by the appended claims.

### DESCRIPTION OF REFERENCE NUMERALS

10: Gas supply cable
11: Gas supply unit (bubble generation point)
20: LED cable
30: Cooler
30′: Cooler (cooling fan)
40: Sealing stopper (for air and/or gas outlet)
41: Conical outlet pipe (material formed of copper)
42: Moisture condensing filter (formed of nano-porous copper metal material)
50: Heater
60: Pump & filtration device
70: Air/gas outlet
80: Cover
100: Container (Reactor)

1. An apparatus for treating wastewater, containing tritium, comprising:
a container for storing wastewater, containing tritium;
an LED cable including an LED light source;
a gas supply cable; and
a transparent cover sealing the container,
wherein the gas supply cable is provided to supply air and carbon dioxide in a form of fine bubbles.

2. The apparatus for treating wastewater, containing tritium, of claim 1, wherein the LED cable comprises a white light source, a red light source, a blue light source and a green light source in one cable, or a combination of cables including each light source in a separate cable.

3. The apparatus for treating wastewater, containing tritium, of claim 1, wherein the fine bubbles comprise bubbles having an average particle diameter of 10 nm to 100 μm.

4. The apparatus for treating wastewater, containing tritium, of claim 1, wherein the gas supply cable is formed of a plurality of gas supply cable layers in a vertical direction at an interval of 50 to 100 cm with respect to a bottom of the container.

5. The apparatus for treating wastewater, containing tritium, of claim 4, wherein the gas supply cable layer forms a horizontal two-dimensional network.

6. The apparatus for treating wastewater, containing tritium, of claim 1, wherein the apparatus further comprises a cooler, a heater, or a combination thereof in the container containing wastewater.

7. The apparatus for treating wastewater, containing tritium, of claim 1, further comprising
a cooler in an upper region of the container in which gas is present.

8. The apparatus for treating wastewater, containing tritium, of claim 1, wherein a lower surface of the cover comprises at least one protrusion with an inclined surface.

9. A method for treating wastewater, containing tritium, comprising:
an operation of pouring wastewater, containing tritium, into a container of the apparatus for treating wastewater, containing tritium, of claim 1;
an operation of injecting microalgae into the container; and
an operation of inducing photosynthesis by using light of an LED cable under microbubbles supplied by a gas supply cable.

10. The method for treating wastewater, containing tritium, of claim 9, wherein the fine bubbles are supplied in an amount of 1.0 to 20.0 m³/hr.

11. The method for treating wastewater, containing tritium, of claim 9, wherein the microalgae is at least one selected from tetraselmis, dunaliella, chlorella, nanno chloropsis, isochrysis, chlamydomonas, golenkinia, hematococcus, spirulina, scenedesmus, and chaetoceros.

12. The method for treating wastewater, containing tritium, of claim 9, wherein the wastewater in the container is maintained at pH of 6 to 8 and a temperature of 15 to 25° C.
